(19) United States
(12) Patent Application Publication
(10) Pub. No.: US 2004/0218781 A1
(43) Pub. Date: Nov. 4, 2004

(54) Index file for use with image data in a document processing system

(76) Inventors: Anton Joseph Kryka, Northville, MI (US); David Andrew LaPorte, Livonia, MI (US)

Correspondence Address: Attn: Lise A. Rode, Unisys Corporation, Unisys Way, MS/E8-114, Blue Bell, PA, 19424-0001, US

(21) Appl. No.: 10/714,121

(22) Filed: Nov. 14, 2003

Related U.S. Application Data
(60) Provisional application No. 60/466,333, filed on Apr. 29, 2003.

(51) Int. Cl. G06K 9/00

(52) U.S. Cl. 382/100

(57) ABSTRACT

An index file for storing and retrieving on an individual basis, imaging data captured by an application running on an imaging subsystem of a document processor, the index file comprising a document-type definition file (DTD) that is processed with the image data by the imaging subsystem application, the imaging subsystem application interpreting the image data according to the document-type definition (DTD) file. The document type definition file preferably has a plurality of first elements related to selected parameters of the document processing system and second elements related to selected parameters of each at least one document that is processed, and further preferably has attributes that describe detailed information about selected ones of the elements. A flexible imaging index file is thus provided that is platform and application independent and that allows for the more facile storage and retrieval of image data from an image file.

### CROSS-REFERENCE TO RELATED APPLICATIONS

This application is related to:

U.S. Patent Application Ser. No. 60/466,333, entitled “Improved System And Method For Storing And Retrieving Images In A Document Processing System” (Kryka et al.), filed Apr. 29, 2003 (this application claiming priority therefrom); and,

U.S. patent application Ser. No. ______ <TBD>, entitled “Improved System And Method For Storing And Retrieving Images In A Document Processing System” (Kryka et al.) filed concomitantly herewith,

both of which are incorporated by reference herein and assigned to the assignee of the present application.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to document processing systems and, more specifically, to an improved image file index for use with image data that is captured, stored and retrieved in document processing systems.

2. Background Art

Automated document processing systems have been used for a number of years to process checks, remittances, and other forms of documents. As many of these automated document processing systems do not share a common lineage, and thus have multiple types of application environments, it is expensive to develop applications for these various document processing systems because each system requires a programmer having a relatively unique skill-set. In view of this problem, Unisys Corporation developed a common programming interface know as the Common Application Programming Interface (CAPI). Unisys CAPI is an object-oriented development environment having an open networking architecture that provides the interface between the document processor hardware modules and the application that interprets the codeline. Unisys CAPI makes easier the development of application programs by permitting programming in different languages; thus also permitting multiple types of document processing systems to be used together despite their different platforms. Currently, a programmer can use Microsoft® Visual Basic®, Microsoft® Visual C++®, Delphi32, or any language that supports the Microsoft OCX (Object Linking and Embedding Control Extension) architecture to program within the CAPI to develop applications. As known to those skilled in the art, properties, methods, and events are constructs that are available with OCX and the Unisys CAPI is defined in terms of these constructs. A property describes a characteristic feature of a document processing system, a method describes a control sequence that can be initiated for a document processing system, and an event indicates status information reported back from a document processor system.

Unisys CAPI currently runs on a number of document processors, including the Unisys Network Document Processor (NDP) 30, 60, 300, 600, 850, 1150, 1600, 1825, and 2000 lines, and the Source Network Document Processor (“Source NDP”). Each of these is commercially available from Unisys Corporation, Unisys Way, Blue Bell, Pa., 19424. The Unisys NDP document processors include transport hardware, and system software on one or more computers that interfaces with the transport hardware in order to provide sorter control and to capture images and check data in various formats. Unisys CAPI (not shown) is part of the system software on the Unisys NDP document processors and runs on the track application PC 14 (FIG. 1). Unisys CAPI preferably also includes a graphical user interface for programming and machine operation. Further detail regarding the Unisys CAPI may be gleaned from U.S. Pat. No. 6,546,396 (Borkowski et al.), entitled “Document Processing System with a Multi-Platform Application Programming Interface,” such patent being assigned to the assignee of the present invention, and incorporated by reference herein.77

In addition to having an environment in which it is easier and less expensive to develop applications for controlling document processors, another factor of crucial importance to the field of document processing is ensuring that document images are successfully and accurately captured. A key factor in achieving this is image storage performance. In the above-mentioned document processing systems from Unisys, as many as five images may be captured per document. These include front and rear JPEG images (gray-scale), front and rear CCITT images (black and white), and a higher resolution front image (gray-scale) that is typically used for image character recognition. The size of this much image data ranges from a typical value of approximately 90 kilobytes to as much as 300 kilobytes per document. By way of example, for the Unisys NDP2000, which runs at 2000 documents per minute (or 33 documents per second), this equates to a storage requirement of 3 to 10 megabytes per second. Compounding the concern of achieving superior image storage performance is the problem of retrieving previously stored images concurrent to the capture of new images. Again, looking to the Unisys NDP2000, this equates to a typical retrieval requirement of 2.3 to 8 megabytes per second.

In order to effect this level of performance, many images are stored in each image file. Once images are captured, an indexing scheme must be used to retrieve single images out of each file of images. The indexing scheme generally used is the Index or IDX scheme, which is a file format consisting of an array of fixed structures. At a more detailed level, the IDX format index file is made up a header and a number of index records. Each index record defines the storage information for one document. An example of an index record for a known IDX index file is shown in Table I below:

TABLE I

| Offset | Length | Name | Description |
|---|---|---|---|
| 0 | 4 | DIN | Document identification number; |
| 4 | 1 | FrontStored | Indicates storage status |
| | | | 0 = No image stored |
| | | | 1 = Image stored |
| 5 | 4 | FrntImgOffset | Offset of image in front image file |
| | | | FFFFFFFF if no image stored |
| 9 | 4 | FrntImgLength | Length of the front image |
| | | | 0 if no image stored |
| 13 | 1 | RearStored | Indicates storage status |
| | | | 0 = No image stored |
| | | | 1 = Image stored |
| 14 | 4 | RearImgOffset | Offset of image in rear image file |
| | | | FFFFFFFF indicates no image stored |
| 18 | 4 | RearImgLength | Length of the rear image |
| | | | 0 if no image stored |
| 22 | 4 | UserDataLen | Length of user data |
| 26 | 231 | UserDataBuffer* | User data buffer from the user data field in the |
| | | | TrackProcessImage. |
| 257 | 1 | CarRequested | Indicates if the courtesy amount recognition (CAR) |
| | | | was requested |
| | | | 0 = not requested |
| | | | 1 = requested |
| 258 | 25 | Front1 Image Information | Image Information Area (see below). |
| 283 | 25 | Rear1 Image Information | Image Information Area (see below). |
| 308 | 25 | Front2 Image Information | Image Information Area (see below). |
| 333 | 25 | Rear2 Image Information | Image Information Area (see below). |
| 358 | 25 | Reserved | |
| 383 | 13 | Front Snippet 1 Info | Image Information Area Snippet (see below). |
| 396 | 62 | Reserved | |
| 458 | 2 | FrontHeaderLength | Length of bytes in the header preceding the image. |
| 460 | 2 | FrontImageWidth | Length in pixels from left to right |
| 462 | 2 | FrontImageHeight | Length in pixels from top to bottom |
| 464 | 1 | FrontThreshold | For threshold information |
| | 2 | FrontCompression | Compression Type |
| | | | Valid values are: |
| | | | 4 = CCITT |
| | | | 6 = JPEG |
| 467 | 2 | FrontXResolution | Pixels per inch |
| 469 | 2 | FrontYResolution | Pixels per inch |
| 471 | 2 | RearHeaderLength | Length in bytes of the header preceding the image |
| 473 | 2 | RearImageWidth | Length in pixels from left to right |
| 475 | 2 | RearImageHeight | Length in pixels from top to bottom |
| 477 | 1 | RearThreshold | For threshold information |
| 478 | 2 | RearCompression | Compression Type |
| | | | Valid values are: |
| | | | 4 = CCITT |
| | | | 6 = JPEG |
| 480 | 2 | RearXResolution | Pixels per inch |
| 465 | 2 | RearYResolution | Pixels per inch |
| 484 | 4 | Internal Analysis | Development information providing performance |
| | | | status. |
| 488 | 1 | Front2Stored | Indicates storage status |
| | | | 0 = No image stored |
| | | | 1 = Image stored |
| 489 | 4 | Frnt2ImgOffset | Offset of image in front2 image file |
| | | | FFFFFFFF if no image stored |
| 493 | 4 | Frnt2ImgLength | Length of the front image |
| | | | 0 if no image stored |
| 497 | 1 | Front2Threshold | For threshold information |
| 498 | 2 | Front2Compression | Compression Type |
| | | | Valid values are: |
| | | | 4 = CCITT |
| | | | 6 = JPEG |
| 500 | 6 | Reserved | [Reserved for future expansion] |
| 506 | 4 | CAR Offset | Offset of CAR data in .CAR file |
| 510 | 2 | Reserved | For integrity testing by the image capture server |
| | | | during image capture. |

As will gleaned from review of Table I, each of the image information areas 258, 283, 308, 333, preferably includes 25 bytes of image information, respectively consisting of Front1 Image Information, Rear1 Image Information, Front2 Image Information, and Rear2 Image Information. Front1 and Front2 refer to two images of the front of the document. Rear1 and Rear2 refer to two images of the rear of the document. In a typical image capture arrangement, the Front1 and Rear1 images can be black and white (CCITT Group 4) images (e.g., for data entry and statement print applications) and Front2 and Rear2 can be gray-scale (JPEG) images (e.g., for archival and recognition tasks).

The format for each of these image information areas 258, 283, 308, 333 is preferably as set forth in Table II below:

TABLE II
Image Information Area

| Offset | Length | Name | Description |
|---|---|---|---|
| 0 | 1 | ImageStored | Indicates storage status. |
| | | | 0 = No image stored |
| | | | 1 = Image stored |
| 1 | 4 | ImgOffset | Offset of image in image file. |
| | | | Is set to FFFFFFFF if no image stored. |
| 5 | 4 | ImgLength | Length of the image. |
| | | | 0 if no image stored. |
| 9 | 1 | Threshhold | For threshhold information, |
| | | | see the Image and CAR |
| | | | Initialization File. |
| 10 | 2 | Resolution | Pixels per inch |
| 12 | 2 | Compression | Value values are: |
| | | | 0 = -Compression information |
| | | | unavailable. (Refer to |
| | | | FontCompression, RearCompression, or |
| | | | Front2Compression for the |
| | | | compression details. |
| | | | 4 = CCITT |
| | | | 6 = JPEG |
| 14 | 11 | Reserved. | |

In addition, image information area 383 may include 13 bytes of image information consisting of an Image Information Area Snippet that preferably includes Front Snippet 1 Information. A snippet is generally defined as a clipped portion of a high resolution JPEG image defined by X,Y coordinates. The Front Snippet1 is typically used for image character recognition, but it can also be used for display and operator data entry if the normal (lower resolution) images cannot be read. The format for image information area 383 is preferably as set forth in Table III below:

TABLE III
Image Information Area Snippet

| Offset | Length | Name | Description |
|---|---|---|---|
| 0 | 1 | ImageStored | Indicates storage status. |
| | | | 0 = No image stored |
| | | | 1 = Image stored |
| 1 | 4 | ImgHdrOffset | Offset of the Snippet File Information |
| 5 | 4 | ImgOffset | Offset of image in snippet image file |
| | | | FFFFFFFF if |
| | | | no image stored. |
| 9 | 4 | ImgLength | Length of the snippet image. |
| | | | 0 if no image stored |

As set forth above, it is desirable to permit programming in different languages particularly where document processors do not share a common lineage, and thus have multiple types of application environments. However, while the fixed image file structures are easily manipulated in C/C++ applications, they are difficult, and in some cases impossible, to manipulate in other programming languages. In addition, the fixed nature of the structure makes it difficult to extend the content of the structures while retaining compatibility with existing applications.

For the foregoing reasons, there is a need for a document processing system with improved document image capturing and retrieving. More specifically, it would be desirable to provide an image file structure that would permit easier manipulation in several programming languages, and the content of the structure of which would be easier to extend while retaining compatibility with existing applications.

### SUMMARY OF THE INVENTION

It is, therefore, an object of the present invention to provide an improved index file format for use with image data.

It is another object of the present invention to provide a flexible index file for use with image data that is captured and stored for subsequent retrieval on an individual basis

It is yet another object of the present invention to provide an improved image index file for use in a multiple document processing system environment, wherein the document processors have different platforms but are operable via a common application programming interface, the image index file for use with image data that is captured and stored for subsequent retrieval on an individual basis.

It is still another object of the present invention to provide an improved index file for an image file, wherein the image file stores a plurality of captured document images for subsequent retrieval on an individual basis, and wherein the indexing file structure is self-describing, the indexing file having elements that describe indexing data for the captured document images.

In accordance with one aspect of an embodiment of the present invention, an index file is provided for retrieving on an individual basis, imaging data captured from at least one document by an application running on an imaging subsystem of a document processor, the index file comprising a document-type definition file that is processed with the image data by the imaging subsystem application, the imaging subsystem application interpreting the image data to be retrieved according to the document-type definition file. The imaging index file of preferably includes a plurality of attributes associated with selected ones of the plurality of elements, the association being set forth in an attribute declaration list, while selected attributes preferably include a choice subgroup, the choice subgroup having at least two values. The plurality of elements may include optional user-defined elements when a predetermined one of the attribute choice subgroup values is selected.

In accordance with another aspect of an embodiment of the invention, the index file comprises a document type definition file having a plurality of element declarations and attribute declarations, the plurality of element declarations including first elements related to selected parameters of the document processing system and second elements related to selected parameters of each at least one document that is processed, wherein the attribute declarations include attributes that describe detailed information about selected ones of the elements.

In accordance with yet another aspect of an embodiment of the invention, selected first elements of the index file include first child elements and selected second elements include second child elements. The first may be elements related to the imaging subsystem, while the second child elements may relate to the documents that are being processed, and which may include a plurality of attributes: defining the at least one document in relation to the imaging subsystem; defining what image character recognition parameters are to be used with the image data of the at least one document; and/or defining image information of each of the at least one document processed by the document processing system.

In accordance with still another aspect of a preferred embodiment of the present invention, the document-type definition file is created in accordance with the extensible markup language (XML).

The above object and other objects, features, and advantages of the present invention are readily apparent from the following detailed description of the preferred embodiment when taken in connection with the accompanying drawings.

### BRIEF DESCRIPTION OF THE DRAWINGS

FIG. 1 illustrates a document processing system including transport hardware and computers running system software in accordance with a preferred embodiment of the present invention; and,

FIGS. 2A and 2B illustrates an example DTD file for a document processing system in accordance with a preferred embodiment of the present invention

FIG. 3 illustrates a diagram showing a document processing system incorporating a preferred embodiment of the present invention;

FIG. 4 illustrates a preferred method of processing image data in a document processing system in accordance with a preferred embodiment of the present invention.

### DETAILED DESCRIPTION OF THE PREFERRED EMBODIMENT

As stated previously, image storage performance is an important key to successfully capturing document images within a document transport, each image file in database 20 stores a plurality of captured document images for subsequent retrieval on an individual basis. An indexing scheme of some sort is therefore necessary in order to retrieve single images out of each image file, but the fixed nature of the commonly-used IDX scheme makes it difficult to extend the content of the structures while retaining compatibility with existing applications. It was therefore determined that another more flexible scheme needed to be considered.

I. Extended Markup Language (XML) and Document Type Definition (DTD)

Developing independently from this need was the rapidly increasing advent of the Internet and Internet/Web-based applications. With this growth came the resulting need for an individual or group of individuals or companies to share information in a consistent way and a requirement for a language that was more flexible than the Hypertext Markup Language (HTML). The World Wide Web Consortium (W3C) offered the Extensible Markup Language (XML) as a solution.

While both XML and HTML contain markup symbols to describe the contents of a page or file, HTML merely describes the content of a Web page only in terms of how it is to be displayed and interacted with. XML and XML elements also describe the content in terms of what data is being described, and these elements are unlimited and self-defining, allowing an application, or other software, developer to create his or her own elements. XML is designed especially to store and transmit data, and changes the way data move across networks, by encapsulating the data, or the information element, inside custom elements that carry semantic information about the element For example, instead of being limited to HTML elements such as <p>12345</p> to indicate that the information “12345” should be displayed in a new paragraph, an XML element <zipcode> could be created to indicate that “12345” is a zipcode; the resulting code would thus be written <zipcode>12345</zipcode>.

As known to those skilled in the art, there are two kinds of legitimate XML documents: well-formed XML documents and valid XML documents. A well-formed XML document conforms to common XML syntax rules and includes uses “tags” or “elements” to distinguish document structures, and “attributes” to encode extra document information. The well-formed XML document is made up of XML “tags” including: “start tags,” which contain a descriptive name (the “tag name” or “element name”) surrounded by angle brackets: <zipcode>; “end tags,” which look similar to start elements, except they have a slash before the tag name: </zipcode>; and, “content,” which is everything between the start tag and the end tag (that is, the information between the two tags; e.g., “12345”). “Elements” or “tags” can contain text, other elements, or be empty. “Attributes” are included in the start tags and provide further detail about the information. Using the above zipcode example, if one wanted to restrict delivery to a particular postal zone, the start tag might look like this: <zipcode zone=“XYZ”>, where “zipcode” is the element name, “zone” is the attribute name, and “XYZ” the attribute value. Attributes can be optional, required, or have a fixed value, and are of a certain “type” (e.g., character data (CDATA), a user-defined enumerated type; ID, IDREF (which are attributes that point from one element to another); and ENTITY, ENTITIES (which are attributes that point to external data in the form of unparsed entities)).

A well-formed XML document must also have a single “root” element that contains the rest of the document, and which cannot exist anywhere else inside the document. Finally, an optional “XML Declaration” can be placed at the top to indicate the version of XML being used and which character encoding the document has.

The second type of legitimate XML document is the valid document. The valid XML document is essentially a well-formed XML document that also conforms to a given document type definition, or DTD. A DTD is a preselected or custom-written definition that specifies the structure of the XML document in a machine-readable way. It defines the following things: what tags can go in the document; what tags can contain other tags; the number and sequence of the tags; the attributes the tags can have; and optionally, the values those attributes can have. A DTD contains “element declarations” to define elements, and “attribute declarations” to define allowable attributes. “Element declarations” set the rules for the type and number of elements that may appear in an XML document, what elements may appear inside each other, and what order they must appear in. “Attribute declarations” identify which element types may have attributes, what type of attributes they may be, and what the default value of the attributes are.

In accordance with the present invention, the “element declarations” generally consist of the following (Table IV, below):

TABLE IV

| | |
|---|---|
| <!ELEMENT | Starts element declaration |
| element-name | The name of the element |
| content-model | The structure of the element's content |
| > | Ends element declaration |

In turn, the “attribute declarations” commonly consist of the following (Table V, below):

TABLE IV

| | |
|---|---|
| <!ATTLIST | Starts attribute declaration |
| element-name | the element for which attributes are being declared |
| attribute-name | the name of the attribute |
| declared-value | the type of attribute, or a list of valid values |
| default-value | the value of the attribute if it is not specified |
| > | ends attribute declaration |

In recognizing the advantage of this flexibility, the inventors have discovered advantages with utilizing the XML DTD file structure in the with image data that is captured, stored and retrieved in networked document processing systems.

II. Document Processing System and Index File Structure

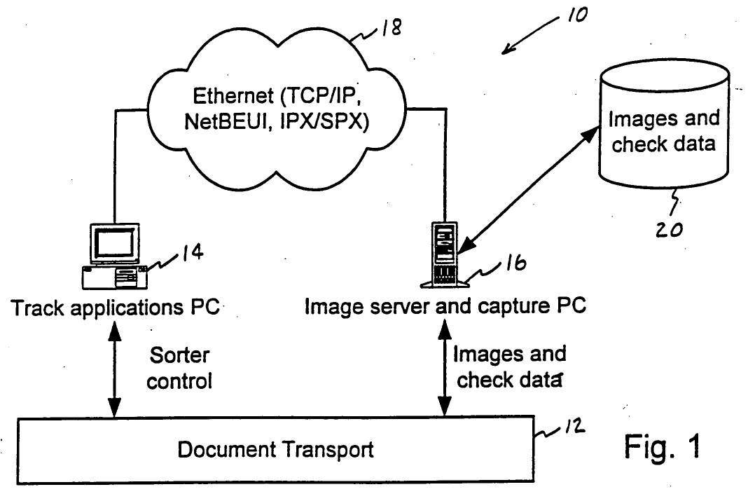

Turning to FIG. 1, a document processing system is generally indicated at 10, which is preferably a Unisys Network Document Processor (NDP) available from Unisys as stated above. Document processing system 10 includes document transport hardware 12 and system software (not shown), which interfaces with document transport hardware 12. The system software runs on computers 14 and 16, although in some Unisys NDP systems, the functions of computers 14 and 16 are combined into one computer. It will be appreciated that both configurations are included in accordance the present invention. In a preferred embodiment, computers 14 and 16 communicate over Ethernet network 18.

Track applications, such as inclearings, proof of deposit, and remittance operations, run on computer 14, and provide sorter control of document transport hardware 12. Computer 16 provides image server and capture capabilities and interfaces with the document transport hardware 12 to receive images and check data and database 20 to store the images and check data. In a preferred embodiment of the present invention, the system software is preferably WINDOWS NT®, WINDOWS® 2000, or WINDOWS® XP-based system software and includes a common application programming interface that enables the same application software to be used across multiple transport platforms. Preferably, the system software is the CAPI system software discussed above and available on various document processors commercially available from Unisys. It will be understood to those skilled in the art that other system software may be used without departing from the spirit and the scope of the invention.

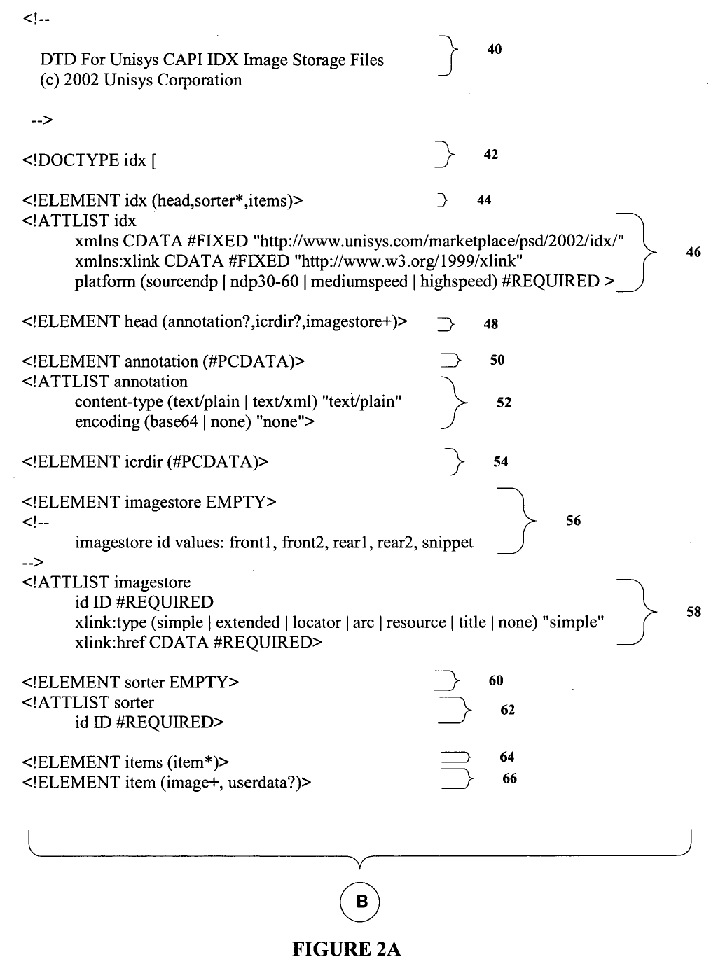

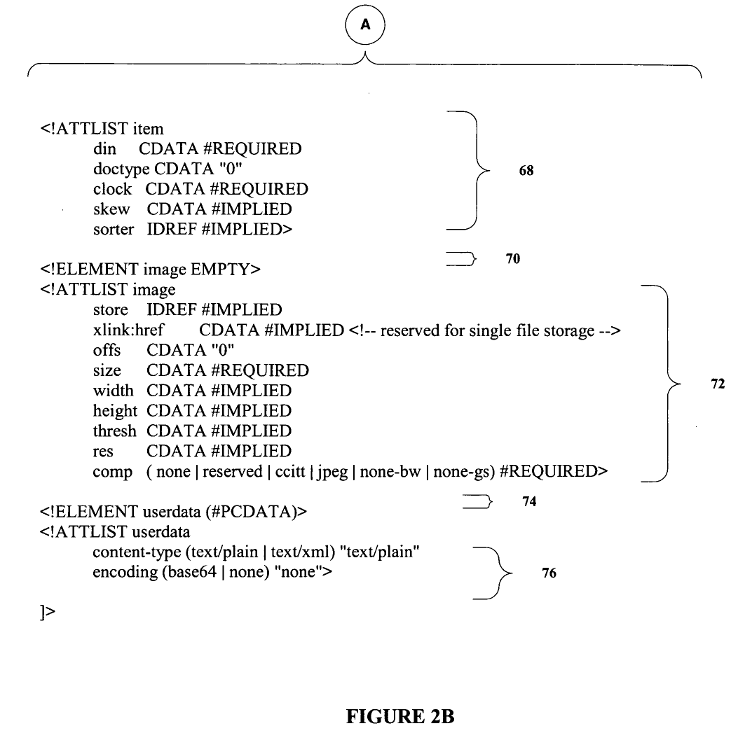

In accordance with a preferred embodiment of the present invention, an example DTD file for a document processing system is shown with reference to in FIGS. 2A and 2B. The DTD file defines the organizational hierarchy of the XML file. The DTD file uses the term “ELEMENT” to define tags, and thus it will be appreciated that within this document, the use of the word “tag” can be interchanged with the word “element,” as these words commonly understood to mean the same thing. In addition, it will be understood that the DTD file of FIGS. 2A and 2B is merely exemplary of the present invention and similar DTD files may be understood to fall within the scope of the invention without departing from the spirit thereof.

The DTD of FIGS. 2A and 2B shows at 40 an optional comment regarding the file and copyright information. It will be understood that any optional comments may be place here or throughout the DTD, as long as it is properly delimited with <!-- and -->, as known to those skilled in the art. Following this declaration at 42 is the document type (DOCTYPE) declaration. The DOCTYPE declaration consists of an internal DTD, references an external DTD, or consists of a combination of both. The DOCTYPE also must reference the root element of the DTD. As will be understood from reference to FIGS. 2A and 2B, the preferred embodiment of the DTD is internal, and the “root element” is declared to be “idx.”

Root element, or tag, “idx” 44 is composed of three child elements: “head,” “sorter,” and “items”. The “idx” element defines the platform in which the image data is being captured, stored and/or retrieved. The “head” element specifies information that is common to all “items”, and the “sorter” element specifies the document transport used to capture the images, and the “items” element corresponds to the documents that were run through a document transport. Only one “head” element should be present immediately after the “idx” begin element. The “sorter” element is optional, but if it is present, it must occur immediately after the “head” end element. Finally, only one “items” element should be present and it should end before the “idx” end element. The following is an example of this organization:

```
<idx ... platform=“sourcendp”>
  <head></head>
  <sorter/>
  <items></items>
</idx>
```

The ATTLIST element 46 preferably includes three attribute: “xmlns,” “xmlns:xlink,” and “platform.” As will be understood from reference to FIGS. 2A and 2B, the first two include standard character data (CDATA), thus text inside the tags will not be treated as markup, entities will not be expanded and thus the text will not be parsed by a parser preferably found in the imaging application. The “xmlns” and “xmlns:xlink” attributes are present to comply with the W3C XML name space standard, and as the value will always be the same, are set to “#FIXED” in the preferred embodiment The “platform” attribute defines the document transport that performed the capture of the images referenced in this file, and is required (i.e., “#REQUIRED”).

The head element 48 is, in turn, preferably composed of three additional optional sub, or child, elements: an “annotation” element 50 (and associated attribute list (ATTLIST) 52), “icrdir” element 54 and “imagestore” element 56 (and associated ATTLIST 58). The “annotation” element 50 includes parsed character data (PCDATA), and therefore tags inside the text will be treated as markup, entities will be expanded and the character data will be parsed by a parser preferably found in an imaging application. This parsed character data corresponds to the data stored by an application in the CAPI DPOCX (Document Processing OCX) properties iImgAnnotate, iImgAnnotateSA, or iImgAnnotateXML. The iImgAnnotate property defines the application annotation data that is stored in the header record of all future image files, and which data can be used by the application to keep information such as business day, type of work, or run number. The iImgAnnotateSA, or iImgAnnotate SafeArray, property is similar to the iImgAnnotate property except that the iImgAnnotateSA property can contain binary data with embedded NULLs (byte value of 0x00). Information regarding these and other CAPI properties is set forth in more detail in U.S. Pat. No. 6,546,396. Finally, in accordance with the present invention, the iImgAnnotateXML property is similar to the aforementioned properties except that the iImgAnnotateXML property specifies that the information is stored in an XML format.

The “content-type” attribute preferably consists of a choice subgroup, having values of “text/plain” or “text/xml,” while the “encoding” attribute preferably consists of a choice subgroup having values of “base64” and “none.” (It will be appreciated that other “content-type” and “encoding” attributes may be represented instead or in addition to these attributes. Similarly, although FIGS. 2A and 2B shows the defaults to respectively be “text/plain” and “none,” it will be appreciated that this is merely exemplary and other default settings may instead be chosen).

As shown in FIGS. 2A and 2B, the attributes are respectively set to “text/plain” and “none.” When an application stores data in these CAPI DPOcx properties, the attributes set forth in attribute list 52 of the “annotation” element 50 are set according to the Table VI:

TABLE VI

| CAPI DPOcx | |
|---|---|
| Property | Resulting Annotation Attributes |
| iImgAnnotate | <annotation context-type=“text/plain” |
| | encoding=“none”> |
| iImgAnnotateSA | <annotation context-type=“text/plain” |
| | encoding=“base64”> |
| iImgAnnotateXML | <annotation context-type=“text/xml” |
| | encoding=“none”> |

As seen in Table VI, if an application stores data in the CAPI DPOcx iImgAnnotateXML property, the resulting annotation attribute is “<annotation context-type=“text/xml” encoding=“none”>. In this case a developer of applications for an imaging system or document processing system, or similar user, may use additional annotation tags such as:

<!ELEMENT dt CDATA #IMPLIED>
<!ELEMENT op CDATA #IMPLIED>
<!ELEMENT trk CDATA #IMPLIED>
<!ELEMENT worktype CDATA #IMPLIED> ... -->

where “dt” includes date information, “op” includes operator information, “trk” includes the ID of the document transport, and “worktype” includes the type of work done: (e.g., OTC (Over The Counter), inclearing, fine sorting, etc.),

The “icrdir” element 54 is parsed character data that references intelligent character recognition (ICR) information. The data is taken from the parameter ICR in the ICRDIR section of the “snippet.ini” file. The “snippet.ini” file is the parameter file that defines which ICR parameters to use. The “imagestore” element 56 is the last child element under the “head” element. This element 56 contains no data, but its attributes give information about the image storage capabilities. The “id” attribute defines which camera is used. The “xlink:type” attribute is an attribute defined by the W3C in its XLink specification. Its value for now will always be “simple.” A simple “xlink:type” associates exactly two resources, one local and one remote, and includes an “arc,” or information about how to traverse the resources, going from the former to the latter. The “xlink:href” attribute is also an attribute defined by the W3C in its XLink specification and defines the remote resource. Its value is the image file name for the corresponding camera used, i.e., the *.Fim (Front Image 1), *.Rim (Rear Image 2), *.Fi2 (Front Image 2), *.Ri2 (Rear Image 2), and *.FS1 (Front Snippet 1), file names.

The “annotation” element 50 is optional, but it can occur at most one time as it corresponds to a single DPOcx property. The “icrdir” element 54 is also optional, but it can occur at most one time by definition since currently only one set of ICR parameters is allowed per index file. The “imagestore” element 56 occurs as many times as it is needed to define all the images taken of each item. For example, one “imagestore” element can define JPEG images and another “imagestore” element will define CCITT images. Continuing with the aforementioned example, the organization would appear as follows:

```
<idx ... platform=“sourcendp”>
  <head>
    <annotation></annotation>
    <icrdir></icrdir>
    <imagestore/>
    <imagestore/>
  </head>
  <sorter/>
  <items></items>
</idx>
```

The “sorter” element 60 is an element with no data and one attribute, “id,” in associated attribute list 62. This attribute contains a value that is used to identify the original capture transport, such as any of the NDP document processors discussed above. In a preferred embodiment, the value is the computer name of the Image Capture Server (ICS) PC and/or the serial number of the transport.

Incorporating the “head element,” its child elements, and their attributes, results in the following example hierarchy:

```
<idx ... platform=“sourcendp”>
  <head>
    <annotation context-type=“text/plain” encoding=“none”>
    2002-05-30@11:00 OTC Early Run</annotation>
    <icrdir>CarDefaultDirectory</icrdir>
    <imagestore id=“front1” xlink:type=“simple”
    xlink:href=“./Bat01037.Fim”/>
    <imagestore id=“rear1” xlink:type=“simple”
    xlink:href=“./Bat01037.Rim”/>
  </head>
  <sorter id=“\\SourceNDP04”/>
  <items></items>
</idx>
```

The last element within the “idx” element 44 is the “items” element 64. Element 64 may contain zero or more “item” elements, and each of these elements corresponds to a document that was run through a document transport. In the example of FIGS. 2A and 2B, “items” element 64 has an “image” element and an optional “userdata” element 66; however, it will be appreciated that these are merely exemplary and other elements may be additionally included or substituted. The “item” element 64 has several attributes as set forth in ATTLIST 68. The “din” attribute is the document identification number that is assigned to the document through the CAPI DPOcx pAppDocDIN property, where the pAppDocDIN property is an application-level document number that ties document processing by the system software to document processing by the application software. The “doctype” attribute is the image character recognition document type that is assigned to the document through the CAPI DPOcx pImgCarDocType property, where the pImgCarDocType property determines the entry from a courtesy amount recognition (CAR) parameter file to be applied to a particular document. The “clock” attribute contains the processor time used by the ICS process as returned in the clock( ) function when the image was successfully stored on disk. The “skew” attribute is the document skew angle in degrees as the document traveled through the image camera, and the “sorter” attribute is a reference to the sorter element.

The “image” element 70 preferably has no data (“EMPTY”), since all of the data is stored in several attributes as set forth in ATTLIST 72. The “store” attribute is a reference to the “imagestore” element 56. As set forth above, the “xlink:href” attribute is also an attribute defined by the W3C in its XLink specification. The “off” attribute is the byte offset within the corresponding image file to select this image. The “size,” “width,” “height” attributes are respectively the size in pixels of this image, the width in pixels of this image, and the height in pixels of this image. The “thresh” attribute is the image threshold value for this image and the “res” attribute is the resolution of this image in dots-per-inch (pixels-per-inch). Finally, the “comp” attribute is the compression type used for this image. As seen in FIGS. 2A and 2B, the compression may be selected from CCITT, JPEG, proprietary (“reserved”), or may be none (i.e., non-compressed gray scale).

The final element or tag in the preferred embodiment of the DTD of the present invention is the optional “userdata” element 74 and associated attribute element ATTLIST 76. The “userdata” element 74 refers to parsed character data, and corresponds to the data stored by an application in the CAPI DPOcx properties pAppDocData, pAppDocDataSA, or pAppDocDataXML. When an application stores data in these CAPI DPOcx properties, the values of the attributes of the “userdata” element are set according to Table VII:

TABLE VII

| CAPI DPOcx PROPERTY | RESULTING USERDATA ATTRIBUTES |
|---|---|
| pAppDocData | <userdata context-type=“text/plain” |
| | encoding=“none”> |
| pAppDocDataSA | <userdata context-type=“text/plain” |
| | encoding=“base64”> |
| pAppDocDataXML | <userdata context-type=“text/xml” |
| | encoding=“none”> |

If an application stores data in the CAPI DPOcx pAppDocDataXML property, the resulting annotation attribute is “<userdata context-type=“text/xml” encoding=“none”>”. In this case a developer of applications for imaging systems or document processing systems, or similar user, may use additional annotation elements in the check fields such as:

<!ELEMENT acct CDATA #IMPLIED>
<!ELEMENT amt CDATA #IMPLIED>
<!ELEMENT chk EMPTY>
<!ELEMENT rt CDATA #IMPLIED>
<!ELEMENT sn CDATA #IMPLIED>
<!ELEMENT stbacct CDATA #IMPLIED>
<!ELEMENT tc CDATA #IMPLIED>
<!ELEMENT tn CDATA #IMPLIED>

where “acct” is account number, “amt” is the amount for which the check is written, “chk” specifies that the document is a check, “rt” indicates the routing and transit number, “sn” represents the sequence number, “stbacct” correlates to the stub account number, “tc” is the transcode, and “tn” represents the transaction number.

In the case of a remittance, such as a paystub or the like, a developer may use different annotation elements such as:

<!ELEMENT acct CDATA #IMPLIED>
<!ELEMENT amt CDATA #IMPLIED>
<!ELEMENT dt CDATA #IMPLIED>
<!ELEMENT stb EMPTY>
<!ELEMENT tc CDATA #IMPLIED>
<!ELEMENT tn CDATA #IMPLIED>

where “acct” represents the account number, “amt,” indicates the stub amount, “df” indicates the date of the stub, “stb” specifies that the document is a stub, “tc” is the transcode, and “tn” represents the transaction number. (As discussed above with regard to the “annotation” element, it will be appreciated that other “content-type” and “encoding” attributes may be represented instead or in addition to these attributes. Similarly, although FIGS. 2A and 2B shows the defaults to respectively be “text/plain” and “none,” it will be appreciated that this is merely exemplary and other default settings may instead be chosen).

Appendix A sets forth an example XML declaration created with the DTD of FIGS. 2A and 2B. As will be appreciated, the document-processing platform on which the image process is run includes at least the Unisys Network Document Processor (NDP) 30, 60, 300, 600, 850, 1150, 1600, 1825, 2000, and Source NDP, all of which are commercially available from Unisys Corporation. However, it will be appreciated that in view of the platform-independent nature of the present invention, other document processing systems and platforms will benefit from the present invention, and are meant to be within the scope hereof.

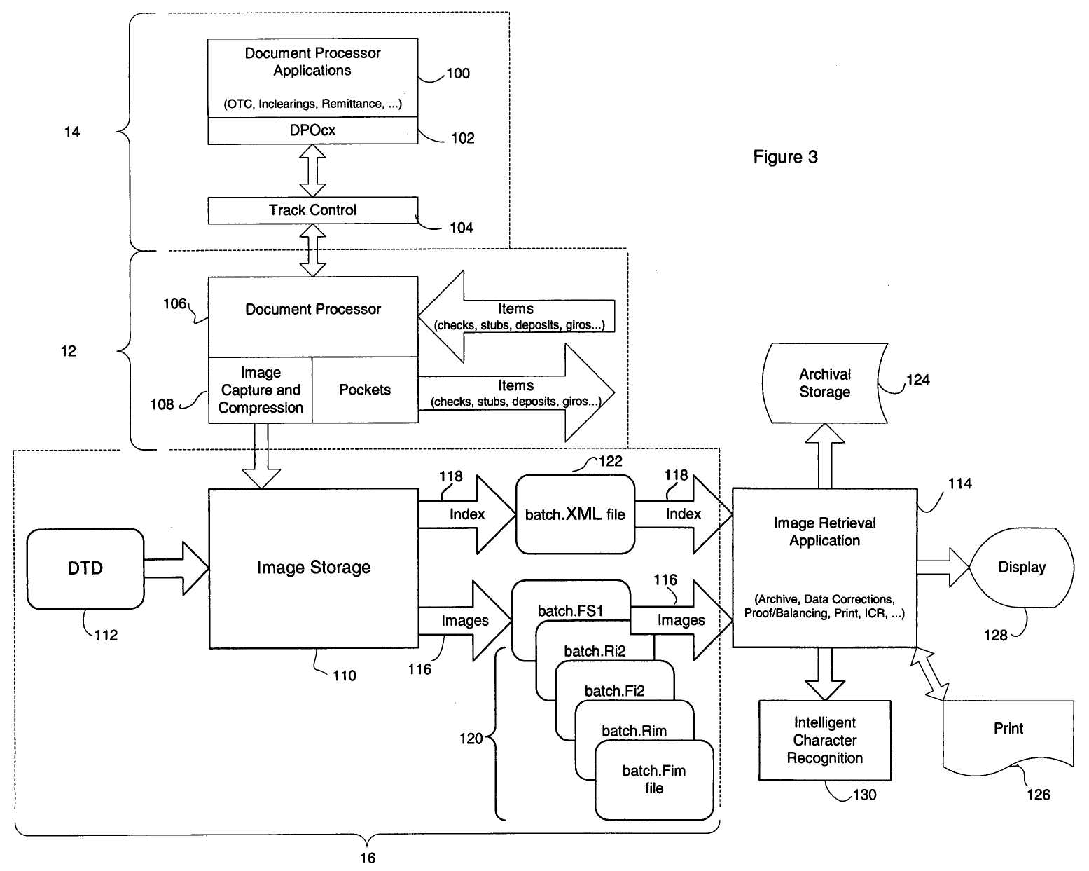

A diagram showing a document processing system incorporating a preferred embodiment of the present invention is shown in FIG. 3. Document processing applications 100, such as OTC, inclearings, and remittance applications that may be written Microsoft® Visual Basic®, Microsoft® Visual C++®, Delphi32, as discussed above, reside on track applications PC 14 (FIG. 1). An object interface 102 is the interface between application 100 and track control 104. Object interface 102 is implemented in OCX and provides a simplified interface between application 100 and document processor 106, provides application events that are consistent with Windows event-driven programming, translates properties into message packets, and checks property boundaries. The object interface 102 also provides control of document processor 106 based on the values of properties set by application program 100, and notifies application program 100 of document processor 102 events through an event reporting mechanism.

Document processor 106 includes an image capture and compression module 108 for capturing image information from received items, or documents, such as checks, stubs, and deposits and for providing as an output, compressed image information for storage in image storage 110. A DTD file 112 such as set forth in FIG. 3 is then used to index and store in image storage a plurality of captured document images for subsequent retrieval on an individual basis. While documents are flowing through the transport 12 and images are being captured and compressed at image capture and compression module 108, image storage 110 outputs images 116 along with an index 118, the latter representing the information for the retrieval of any image from the group of image files 120 (where a group of image files corresponds to what is typically called a “batch” or “block” of documents). The batch image files 120 preferably include the following files: FS1 (Front Snippet 1), Ri2 (Rear Image 2), Fi2 (Front Image 2), Rim (Rear Image 1), and Fim (Front Image 1). The index 118 is then used to generate an XML file 122. After a group of images has been captured, the document processor application 100 signals the DPOcx 102 that the index and image files are to be closed. At this time an image retrieval application 114 can start processing the images. It reads the index file 118 and then the corresponding images that it needs to perform a function. This function may include retrieval of only a few images or all of the images. Typical retrieval applications include image archive, data corrections, proof and balancing, statement print, and intelligent character recognition. The retrieved images may then be stored by the image retrieval application 114 in archival storage 124, printed via a printer device 126, displayed on a display 128 (such as a monitor of the track applications PC 14), and/or provided to an ICR subsystem for intelligent character recognition processing 130.

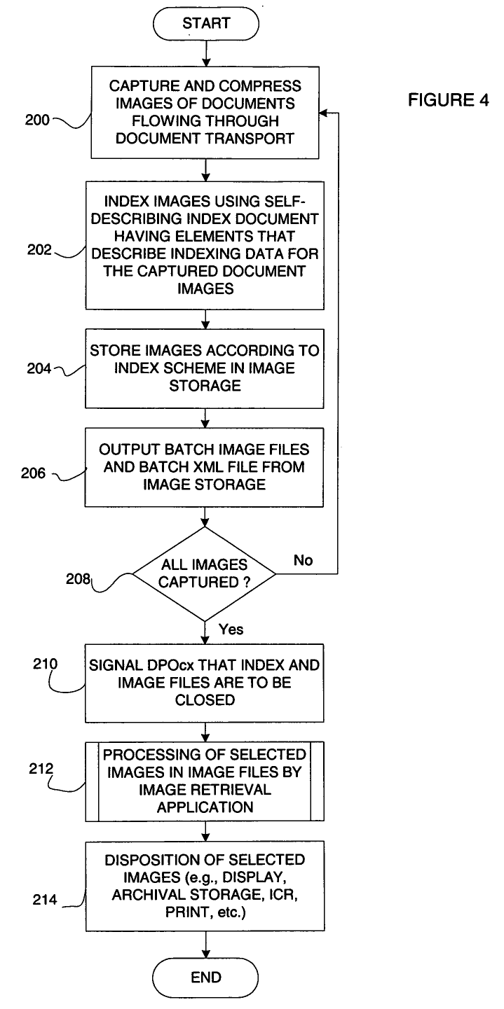

A method of operating a document processing system using the index file structure of the present invention will be discussed with reference to FIGS. 3 and 4. At step 200, images from documents flowing through document transport 12 are captured and compressed. These images are then indexed according to the DTD of the present invention (step 202) and stored according to the DTD index at step 204. Image storage 110 outputs the batch image files 120 and batch XML file 122 created from the DTD index, at step 206. Assuming that all images are captured, the document processor application 100 signals the DPOcx 102 that the index and image files are to be closed (as set forth above)(step 210). The image retrieval application 114 then retrieves selected ones of images (or all images) at step 212, and stores, prints, displays, provides to an ICR subsystem, or otherwise similarly further disposes of the retrieved images.

It will be appreciated that as the index file structure of the present invention is application and platform-independent, a more flexible indexing scheme is provided that allows for the more facile storage and retrieval of individual image data from an image file. Thus the problems with fixed image filing structures, such as IDX or the like, are avoided. In addition, the application-independent nature of the index file structure of the present invention permits the continued programming of document processing system applications in legacy and/or proprietary languages, which is expected to result in cost savings. It will be further appreciated that the flexible index file structure of the present invention allows a user or application developer to easily add additional custom attributes or extend the content of the image structures without affecting existing document processing applications.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

```
APPENDIX A
<?xml version=“1.0” ?>
    - <!--
        Unisys Document Processor Common API Image File
  -->
- <idx xmlns=“http://www.unisys.com/marketplace/psd/2002/idx/”
    xmlns:xlink=“http://www.w3.org/1999/xlink” platform=“ndp30-60”>
  - <head>
      <annotation
        encoding=“base64”>RFAgIFRyYW5zcG9ydCBFeGVyY2lzZXIgSW1hZ2UgQ2Fwd
        HVyZQAAAAAAAAAAAAAAAAAAAAAAAAAAAAAAAAAAAAAAAAAAAAAAAAAAAAA
        AAAAAAAAAAAAAAAAAAAAAAAAAAAAAAAAAAAAAAAAAAAAAAAAAAAAAAAAAA
        AAAAAAAAAA=</annotation>
      <icrdir />
      <imagestore id=“front1” xlink:type=“simple” xlink:href=“./OCT07B.FIM” />
      <imagestore id=“rear1” xlink:type=“simple” xlink:href=“./OCT07B.RIM” />
      <imagestore id=“front2” xlink:type=“simple” xlink:href=“./OCT07B.FI2” />
      <imagestore id=“rear2” xlink:type=“simple” xlink:href=“./OCT07B.RI2” />
      <imagestore id=“snippet” xlink:type=“simple” xlink:href=“./OCT07B.FS1” />
    </head>
  - <items>
    - <item din=“1” clock=“237751”>
        <image store=“front1” offs=“512” size=“10452” width=“1440” height=“648”
          thresh=“16” res=“240” comp=“ccitt” />
        <image store=“rear1” offs=“512” size=“1070” width=“1440” height=“652”
          thresh=“16” res=“240” comp=“ccitt” />
        <userdata
          encoding=“base64”>LwECOjM5ODMwMDAwMDA6ICAgICAgNDA2MCA8ODc2
          NTQzMjEgOzU0OTM9NTk0MjsAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAA</userdata>
      </item>
    - <item din=“2” clock=“239664”>
        <image store=“front1” offs=“10964” size=“10364” width=“1440” height=“644”
          thresh=“16” res=“240” comp=“ccitt” />
        <image store=“rear1” offs=“1582” size=“974” width=“1440” height=“652”
          thresh=“16” res=“240” comp=“ccitt” />
        <userdata
          encoding=“base64”>LwECOjU0MzIxMDAwMDA6ICAgICAgNzA4MCA8ODc2NT
          QzMjEgOzU0OTM9NTk0MjsAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAA</userdata>
      </item>
  - <item din=“3” clock=“241617”>
        <image store=“front1” offs=“21328” size=“14210” width=“1440” height=“644”
          thresh=“16” res=“240” comp=“ccitt” />
        <image store=“rear1” offs=“2556” size=“900” width=“1440” height=“648”
          thresh=“16” res=“240” comp=“ccitt” />
        <userdata
          encoding=“base64”>LwECOjk1Njc4MDAwMDA6ICAgICAgMTExMCA8ODc2NT
          QzMjEgOzU0OTM9NTk0MjsAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAA</userdata>
      </item>
    - <item din=“4” clock=“243560”>
        <image store=“front1” offs=“35538” size=“8524” width=“1440” height=“644”
          thresh=“16” res=“240” comp=“ccitt” />
        <image store=“rear1” offs=“3456” size=“900” width=“1440” height=“648”
          thresh=“16” res=“240” comp=“ccitt” />
        <userdata
          encoding=“base64”>LwECOjAwNDAwMDAwMDA6ICAgICAgOTA2MCA8ODc2N
          TQzMjEgOzU0OTM9NTk0MjsAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAA</userdata>
      </item>
    - <item din=“5” clock=“245513”>
        <image store=“front1” offs=“44062” size=“15082” width=“1440” height=“644”
          thresh=“16” res=“240” comp=“ccitt” />
        <image store=“rear1” offs=“4356” size=“926” width=“1440” height=“648”
          thresh=“16” res=“240” comp=“ccitt” />
        <userdata
          encoding=“base64”>LwECOjk1Njc4MDAwMDA6ICAgICAgMTExMCA8ODc2NT
          QzMjEgOzU0OTM9NTk0MjsAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAA</userdata>
      </item>
    - <item din=“6” clock=“247455”>
        <image store=“front1” offs=“59144” size=“14692” width=“1440” height=“644”
          thresh=“16” res=“240” comp=“ccitt” />
        <image store=“rear1” offs=“5282” size=“1040” width=“1440” height=“648”
          thresh=“16” res=“240” comp=“ccitt” />
        <userdata
          encoding=“base64”>LwECOjIzNDU2MDAwMDA6ICAgICAgMjAxMCA8ODc2NT
          QzMjEgOzU0OTM9NTk0MjsAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAA</userdata>
      </item>
    - <item din=“7” clock=“249398”>
        <image store=“front1” offs=“73836” size=“9562” width=“1440” height=“644”
          thresh=“16” res=“240” comp=“ccitt” />
        <image store=“rear1” offs=“6322” size=“1238” width=“1440” height=“648”
          thresh=“16” res=“240” comp=“ccitt” />
        <userdata
          encoding=“base64”>LwECOjIxNDQwMDAwMDA6ICAgICAgNTA2MCA8ODc2N
          TQzMjEgOzU0OTM9NTk0MjsAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAA</userdata>
      </item>
    - <item din=“8” clock=“251341”>
        <image store=“front1” offs=“83398” size=“12224” width=“1440” height=“648”
          thresh=“16” res=“240” comp=“ccitt” />
        <image store=“rear1” offs=“7560” size=“946” width=“1440” height=“648”
          thresh=“16” res=“240” comp=“ccitt” />
        <userdata
          encoding=“base64”>LwECOjAwMDAxMDAwMDA6ICAgICAgMzA1MCA8ODc2N
          TQzMjEgOzU0OTM9NTk0MjsAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAA</userdata>
      </item>
    - <item din=“9” clock=“253294”>
        <image store=“front1” offs=“95622” size=“18358” width=“1440” height=“644”
          thresh=“16” res=“240” comp=“ccitt” />
        <image store=“rear1” offs=“8506” size=“974” width=“1440” height=“648”
          thresh=“16” res=“240” comp=“ccitt” />
        <userdata
          encoding=“base64”>LwECOjY0MDMyMDAwMDA6ICAgICAgMTA1MCA8ODc2N
          TQzMJEgOzU0OTM9NTk0MjsAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAA</userdata>
      </item>
    - <item din=“10” clock=“255186”>
        <image store=“front1” offs=“113980” size=“21612” width=“1440”
          height=“644” thresh=“16” res=“240” comp=“ccitt” />
        <image store=“rear1” offs=“9480” size=“3268” width=“1440” height=“648”
          thresh=“16” res=“240” comp=“ccitt” />
        <userdata
          encoding=“base64”>LwECOjU4NzMwMDAwMDA6ICAgICAgODAxMCA8ODc2N
          TQzMjEgOzU0OTM9NTk0MjsAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAAAAAAAAAAAAAAAAAAAAA
          AAAAAAAAAAAAAAAAAAAAAAAAAAAAAAAAAAAAAA</userdata>
      </item>
    </items>
  </idx>
```

What is claimed is:

1. An index file for retrieving on an individual basis, imaging data captured from at least one document by an application running on an imaging subsystem of a document processor, the index file comprising a document-type definition file that is processed with the image data by the imaging subsystem application, the imaging subsystem application interpreting the image data to be retrieved according to the document-type definition file.

2. The imaging index file of claim 1, wherein the document-type definition file includes a plurality of elements delineating parameters of the document processor.

3. The imaging index file of claim 2, wherein the document-type definition file further includes a plurality of attributes associated with selected ones of the plurality of elements, the association being set forth in an attribute declaration list.

4. The imaging index file of claim 3, wherein selected attributes include a choice subgroup, the choice subgroup having at least two values.

5. The imaging index file of claim 4, wherein the plurality of elements include optional user-defined elements when a predetermined one of the attribute choice subgroup values is selected.

6. The imaging index file of claim 5, wherein the document is a check.

7. The imaging index file of claim 6, wherein the user-defined elements include a check account number element.

8. The imaging index file of claim 6, wherein the user-defined elements include an element delineating that the document is a check.

9. The imaging index file of claim 6, wherein the user-defined elements include a check amount element.

10. The imaging index file of claim 6, wherein the user-defined elements include a check account number element.

11. The imaging index file of claim 6, wherein the user-defined elements include a check 0routing and transit number element.

12. The imaging index file of claim 6, wherein the user-defined elements include a check sequence number element.

13. The imaging index file of claim 6, wherein the user-defined elements include a transaction number element.

14. The imaging index file of claim 6, wherein the user-defined elements include a transcode element.

15. The imaging index file of claim 5, wherein the document is a stub.

16. The imaging index file of claim 15, wherein the wherein the user-defined elements include an account number element.

17. The imaging index file of claim 15, wherein the wherein the user-defined elements include an amount element.

18. The imaging index file of claim 15, wherein the wherein the user-defined elements include a date element.

19. The imaging index file of claim 15, wherein the wherein the user-defined elements include an element delineating that the document is a remittance.

20. The imaging index file of claim 15, wherein the wherein the user-defined elements include a transcode element.

21. The imaging index file of claim 15, wherein the wherein the user-defined elements include a transaction number element.

22. The imaging index file of claim 5, wherein the plurality of user-defined elements includes parsed character data.

23. The imaging index file of claim 5, wherein the plurality of user-defined elements includes unparsed character data.

24. The imaging index file of claim 5, wherein the imaging subsystem application includes a parser for interpreting the image data according to the document-type definition file.

25. The imaging index structure of claim 1, wherein the document processor is capable of being connected to other document processors via a network.

26. A file for indexing data captured by an imaging subsystem of a document processing system from at least one document, the index file comprising a document type definition file having a plurality of element declarations and attribute declarations, wherein the plurality of element declarations include first elements related to selected parameters of the document processing system and second elements related to selected parameters of each at least one document that is processed, and wherein the attribute declarations include attributes that describe detailed information about selected ones of the elements, the index file being associated with the image data in an imaging file in the imaging subsystem.

27. The index file of claim 26, wherein selected first elements include first child elements and selected second elements include second child elements.

28. The index file of claim 27, wherein the first child elements are elements defining the attributes and data that are common to subsequent elements.

29. The index file of claim 27, wherein the first child elements are elements related to the imaging subsystem.

30. The index file of claim 29, wherein the imaging subsystem includes image storage means, and first child element is an element defining the identity of the image storage means.

31. The index file of claim 29, wherein the imaging subsystem includes a camera, and wherein the first child element has at least one attribute, the attribute being the identity of the camera.

32. The index file of claim 29, wherein the imaging subsystem includes a camera, and wherein the first child element has at least one attribute, the attribute being the identity of the image file associated with the camera.

33. The index file of claim 29, wherein the document processing system includes an image capture server, and the first child element is an element defining the identity of the image capture server.

34. The index file of claim 33, wherein the element defining the identity of the image capture server has at least one attribute, the attribute having a value identifying the document processing system.

35. The index file of claim 34, wherein the value identifying the document processing system is selected from the group consisting of a name of the image capture server and a serial number associated with the document processing system.

36. The index file of claim 27, wherein the second child elements include a plurality of attributes defining the at least one document in relation to the imaging subsystem

37. The index file of claim 36, wherein the imaging subsystem includes image storage means, wherein one attribute includes information related to the time it took to store image data of the at least one document in the image storage means.

38. The index file of claim 36, wherein the imaging subsystem includes a camera, and one attribute includes information about the skew angle of each at least one document in relation to the camera.

39. The index file of claim 27, wherein the second child elements include parsed character data defining what image character recognition parameters are to be used with the image data of the at least one document.

40. The index file of claim 39, wherein selected image data of the at least on document are captured as a clipped portion of a JPEG image, wherein the image file includes a sub-folder that sets out the coordinates to use when capturing the clipped portion of the JPEG image, and wherein the image character recognition parameters are located in the image file sub-folder.

41. The index file of claim 27, wherein the second child elements include a plurality of attributes defining image information of each of the at least one document processed by the document processing system.

42. The index file of claim 41, wherein one attribute includes a document identification number.

43. The index file of claim 41, wherein one attribute includes image character recognition type.

44. The index file of claim 41, wherein the plurality of image information attributes include information relating to the dimensions of the image.

45. The index file of claim 41, wherein the image information attributes include information relating to the resolution of the image.

46. The index file of claim 41, wherein the image information attributes include information relating to the compression of the image.

47. The index file of claim 41, wherein the image information attributes include information relating to the threshold value for the image.

48. The index file of claim 26, wherein the document processor is capable of being connected to other document processors via a network.
